(19) United States
(12) Patent Application Publication
(10) Pub. No.: US 2026/0308057 A1
(43) Pub. Date: Oct. 8, 2026

(54) Recycled Drywall Products and Systems

(71) Applicants: Robert Gordon Heemskerk, Edmonton (CA); Darcy MacPherson, Edmonton (CA)

(72) Inventors: Robert Gordon Heemskerk, Edmonton (CA); Darcy MacPherson, Edmonton (CA)

(73) Assignee: Qualico Developments West Ltd., Edmonton, AB (CA)

(21) Appl. No.: 19/169,601

(22) Filed: Apr. 3, 2025

Related U.S. Application Data
(60) Provisional application No. 63/574,422, filed on Apr. 4, 2024.

(51) Int. Cl. C04B 18/167; C04B 28/14; C04B 111/00; C04B 111/28; C04B 111/52

(52) U.S. Cl. CPC C04B 18/167; C04B 28/14; C04B 2111/00155; C04B 2111/00577; C04B 2111/0062; C04B 2111/28; C04B 2111/52

(57) ABSTRACT

A fireproof liquid or paste is taught comprising a drywall powder; and a fireproof adhesive. A dry mixture is further taught, comprising a gypsum powder at least in part derived from a gypsum component of drywall; and a fibre component at least partly from backing or facing papers of drywall. The fibrous component provides the structural integrity to the dry mixture. A fireproof construction panel or tile is further provided, comprising a gypsum powder at least in part derived from a gypsum component of drywall; a fibre component at least partly from backing or facing papers of drywall; one or more binding agents; and one or more lightening materials. The fibrous component provides the bulk density and structural integrity to the construction panel or tile.

### CROSS REFERENCE AND PRIORITY TO RELATED APPLICATIONS

This application claims the benefit of priority to: U.S. Provisional No. 63/574,422 entitled “SYSTEM AND METHOD FOR DRYWALL RECYCLING,” filed on Apr. 4, 2024.

All the aforementioned applications are hereby incorporated by reference in their entirety.

### FIELD

The present disclosure generally relates to products and systems for recycled drywall and related gypsum products.

### BACKGROUND

Drywall, also known as gypsum board, plasterboard, or wall board, is used in building construction to create interior walls and ceilings, as well as architectural features like eaves, arches and doorways. Drywall most commonly takes the form of panels of gypsum (calcium sulfate dihydrate), with or without additives, that are extruded or pressed between sheets of paper. Some of the additives that can be present in drywall include mica, clays and resin. Drywall installation typically involves screwing drywall panels to a building's struts and support beams in a side-by-side fashion to form an interior wall or ceiling.

Drywall panels need to be cut into pieces that can fit small spaces, angles and narrow sections of the interior surfaces to be covered. The process produces inherent waste in the form of drywall off-cuts that cannot then be used in other places in the building construction.

As a result, approximately 95% of waste drywall from construction currently ends up in landfills. Decaying gypsum from waste drywall in landfills is well known to off-gas hazardous chemicals such as hydrogen sulfide, as well as creating significant odour issues. Typical drywall additives include plasticizers, foaming agents, anti-mildew agents, and chelating agents.

Prior attempts at recycling gypsum drywall board have focused on separating the gypsum core from the protective layers of paper for the purposes of recycling. In U.S. Pat. Nos. 11,780,774 B2 and 11,840,484 B2, gypsum waste is separately pulverized into a gypsum powder and the protective layers of paper are separately shredded. The pulverized gypsum powder and the shredded paper is then mixed together with a binder to form a waste structural composition such as a brick or a tile.

In known prior arts, for example in US20070212495A1, U.S. Pat. Nos. 8,519,024B2, 6,162,288A, 6,783,345B2 and 10,487,218B2, gypsum-based formulations, obtained from natural sources of gypsum are used in fireproof coating of various structural surfaces.

In a small minority of instances, the paper covering of drywall is removed and the gypsum may be re-introduced into making other gypsum boards. In another small minority of cases, the gypsum component of the drywall waste can be ground up for use in fertilizer or as concrete additive. Such uses are less common since they require the coordination of very different industries working together to transport waste drywall to other sites for these other end users. These uses are also significantly limited in how much waste drywall can be actually reused or recycled.

The paper waste from drywall is most commonly removed in drywall recycling processes and then can be combusted but is primarily sent to landfill.

### SUMMARY

A fireproof liquid or paste is taught comprising a drywall powder; and an adhesive.

A dry mixture is further taught, comprising a gypsum powder at least in part derived from a gypsum component of drywall; and a fibre component at least partly from backing or facing papers of drywall. The fibrous component provides the structural integrity to the dry mixture.

A fireproof construction panel or tile is further provided, comprising a gypsum powder at least in part derived from a gypsum component of drywall; a fibre component at least partly from backing or facing papers of drywall; one or more binding agents; and one or more lightening materials. The fibrous component provides the bulk density and structural integrity to the construction panel or tile.

It is to be understood that other aspects of the present disclosure will become readily apparent to those skilled in the art from the following detailed description, wherein various embodiments of the disclosure are shown and described by way of illustration. As will be realized, the disclosure is capable of other and different embodiments and its several details are capable of modification in various other respects, all without departing from the spirit and scope of the present disclosure. Accordingly, the drawings and detailed description are to be regarded as illustrative in nature and not as restrictive.

### DETAILED DESCRIPTION

The description that follows and the embodiments described therein are provided by way of illustration of an example, or examples, of particular embodiments of the principles of various aspects of the present disclosure. These examples are provided for the purposes of explanation, and not of limitation, of those principles and of the disclosure in its various aspects.

The present disclosure provides for products to be made from components of drywall and more preferably of waste drywall, said products that can impart fireproofing and/or sound deadening to construction surfaces. The products include a dry, mixture, a fireproof and/or sound deadening liquid or paste and fireproof and/or sound deadening construction tiles or panels, each comprising. The drywall or waste drywall can be sourced and processed directly at the building construction site where drywall is being used, to form products that can be used directly in the building construction project on site. The products of the present disclosure can be then applied to surfaces including wood surfaces, metal surfaces, concrete, and the surface of insulation, both rigid and spray-foam insulation.

### Dry Mixture

A dry mixture is obtained comprising a gypsum powder, as well as a fibrous component at least partly obtained from backing or facing papers of drywall. The fibrous component provides the structural integrity to the dry mixture.

When mixed with suitable flow additives, water, or diluents, the dry mixture, the fibrous component creates a web-like structure that improves bulk density and mechanical strength. The gypsum powder component provides fire-resistant properties, although further fireproofing additives can also be added. It would be well understood by those in the art that other additives, including those that improve sound deadening can be added to the dry mixture to achieve a paste or liquid having sought after properties.

The present gypsum powder is preferably sourced from drywall, wallboard, plasterboard, gypsum panels including construction waste of various shapes and sizes such as panels, blocks, cut-outs, shards, or portions thereof. In an embodiment, gypsum powder can further include non-gypsum elements such as glass or paper fibres and other additives.

In some embodiments, the fibrous components used in the dry mixture consists of drywall facing and backing papers. The backing and facing papers are shredded, ground milled or otherwise broken down to a fine shred using a shredder or the like. Additional fiber from other wastepaper feedstock can also be incorporated into the mixture.

The backing and facing papers might be shredded or ground with the interior gypsum core, so the drywall is broken down as a whole. Alternatively, the facing and backing papers may be mechanically separated from the gypsum panels and separately processed (e.g., shredded) and reincorporated into a mixture with the gypsum powder. The shredded paper forms the fibrous components that enhances bulk density and structural reinforcement when mixed with adhesives or binders.

In some embodiments, the dry mixture can be compressed in a pressing process to form construction panels and tiles, wherein the gypsum powder component of the dry mixture imparts fireproofing characteristics to the panels or tiles.

In a further alternate embodiment, the dry composition can be applied, for example by spraying along with a spray insulation, to impart fireproofing to the insulation. Flow additives and/or water or other solvents and diluents can also be added in this embodiment. This can be at the construction site or at other locations.

### Fireproof Liquid or Paste

A fireproof liquid or paste is obtained from a drywall powder comprising at least powdered gypsum from the drywall and an adhesive. In some embodiments the adhesive may impart additional fireproofing performance to the liquid or paste.

The liquid or paste can be applied to various construction surfaces, including wood, steel, concrete, mechanical, and plumbing fixtures, and insulation surfaces, including both rigid and spray foam insulation. The liquid or paste imparts fireproofing and also sound deadening to such surfaces.

The fireproof liquid or paste may also include a fibre component from backing or facing papers of drywall, preferably from waste drywall, said fibre component serving to provide bulk density to the liquid or paste. The facing and backing papers from the drywall can be shredded, pulverized, or otherwise broken down together with the gypsum component of the drywall, by mulching or otherwise. Alternatively, the backing and facing papers can optionally be removed from the gypsum core of the drywall and broken down by a secondary process. The fibre component serves to impart bulk density and structural integrity to the liquid or paste, and to the final fireproofing layer formed on the construction surface.

To adjust viscosity and flowability, additional components such as flow additives, water, or diluents may be included. This ensures that the liquid or paste can be either sprayed or manually applied, depending on the requirements of the construction surface. Further additives to improve sound deadening can also be added.

The gypsum powder and the fiber components of the present compositions come from waste drywall that is mulched and optionally also ground to a powder. Mulching and grinding may take place in a single piece of equipment in a one-step process or can take place in two separate steps of first mulching pieces waist drywall, then grinding the mulch. The mulching and grinding may be done at the construction site using a mobile mulcher and a mobile grinder or a combined mobile mulcher/grinder. Alternatively, mulching and griding can optionally take place at a separate location, which can be a processing facility or another construction site using a stationary mulcher and grinder or a combination stationary mulcher/grinder. The waste drywall can be mulched and ground with the sheets of paper that make up the drywall back and face papers, or such paper can be removed ahead of processing.

Mixing of the dry mixture with the adhesive and optionally other additives can take place on site, at another construction site, or at a processing facility. Mixing can take place in a motorized or hand mixer device, or mixing can occur simply manually in a vessel with any mixing instrument.

The adhesive can be any suitable substance that can hold the drywall mulch or powder together and that reasonably resists separation or degradation. Adhesive that could be used in the present process can include cements, mucilage, glues, and pastes that can form an adhesive bond and that show proven fireproofing and/or sound deadening characteristics.

The mixture of the adhesive and mulched or ground drywall can optionally be thinned with water or suitable solvents or diluents. Other suitable additives can optionally also be added, to provide a target viscosity and flowability.

The resultant liquid or paste, with or without flow additives and/or water, can then be sprayed or hand applied or troweled onto surfaces at the construction site or at other construction sites. Such surfaces can include surfaces of insulation, including sprayed, rigid, and non-rigid forms insulation, as well as wood, steel, concrete, mechanical or plumbing fixtures. As is well known, spray foam and rigid insulation are not inherently fireproof and must be coated to provide fireproofing.

The liquid or paste, with or without flow additives, is then allowed to cure and dry to form a fire-resistant and/or sound deadening layer on the surface. A level of fire resistance and/or noise resistance can vary based, among other factors density of the ground drywall, content of fireproofing adhesive and the thickness the layer of liquid or paste that is applied.

The fireproof liquid or paste, with or without flow additives and/or water, can be applied through spray gun onto the surface. The spray gun can be connected by a hose to a source of the liquid or paste and may also utilize air pressure to allow for spraying. Such spray guns are known in the art. The air pressure may be created using a compressor or air pressure pumps.

### Fireproof Construction Tile or Panel

The present disclosure also provides fireproof construction tiles or panels made from drywall products, preferably waste drywall products. The panels can be comprised of powdered gypsum derived from a gypsum portion of the drywall and a fibrous component derived at least partly from the facing and backing papers of the drywall. These panels or tiles have inherent sound deadening characteristics.

The gypsum powder component of the construction panels or tiles imparts fireproofing characterises to the panels or tiles. The tiles or panels may also comprise further or additional fireproofing agents such as further fireproofing adhesives. The other components of the fireproof or sound deadening tiles or panels can include foaming agents, binding agents, adhesives, lightening materials such as mineral fibers, perlite, and fiberglass.

Any additives to enhance structural integrity and/or decrease weight of the product without affecting fireproof properties would be understood to be suitable and included in the manufacture of the present panels or tiles. Binders may also be required to keep components comingled and bonded together. Some components would enhance fireproofing aspects while others can lighten the product.

The panels or tiles can be made in a pressing process, from a dry mixture of gypsum powder and the fibrous component. Further additives to enhance stability, adhesion and strength can be included in the pressing process and the final panels or tiles.

The construction tiles or panels may also be made into a liquid or paste using adhesives, viscosity adjusting agents, flow additives, water, or diluents and then poured and set into the construction panels or tiles.

The panels and tiles can be extruded and formed; foamed, extruded and formed; sprayed and formed or laminated.

Such fireproof construction tiles or panels can be adhered or bonded, or mechanically affixed nails or screws directly to surfaces including wood, steel, concrete, mechanical or plumbing fixtures or insulation surfaces, either rigid insulation or spray insulation, to provide fireproofing or sound deadening qualities.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A dry mixture, comprising:
a. gypsum powder at least in part derived from a gypsum component of drywall; and
b. a fibre component at least partly from backing or facing papers of drywall;
wherein the fibrous component provides the structural integrity to the dry mixture, wherein the dry mixture when applied to a construction surface, imparts sound deadening to that surface.

2. The dry mixture of claim 1, wherein said mixture is configured for mixing with an adhesive for forming a fireproof liquid or paste.

3. The dry mixture of claim 1, wherein said mixture is configured for application by spraying, in conjunction with a separately sprayed spray foam insulation, to thereby coat the spray foam insulation and impart fireproofing to the insulation.

4. The dry mixture of claim 2, wherein the construction surface comprises wood surfaces, metal surfaces, concrete surfaces, surfaces of mechanical or plumbing fixtures or insulation surfaces.

5. A fireproof liquid or paste comprising:
a. a drywall powder; and
b. an adhesive.

6. The fireproof liquid or paste of claim 5, wherein the drywall powder comprises powdered gypsum from the drywall.

7. The fireproof liquid or paste of claim 6, further comprising a fibre component from backing or facing papers from the drywall, said fibre component serving to provide bulk density to the liquid or paste.

8. The fireproof liquid of paste of claim 5, wherein the adhesive is a fireproof adhesive.

9. The liquid or paste of claim 5, further comprising water, one or more flow additives, or one or more diluents to adjust the viscosity and flowability of the paste or liquid.

10. The liquid or paste of claim 9, wherein the liquid or paste is configured to be sprayed or hand applied or troweled to a construction surface.

11. The liquid or paste of claim 9, wherein the liquid or paste forms a layer on the construction surface, to convey fire resistance to the construction surface.

12. The liquid or paste of claim 9, wherein the liquid paste forms a layer on the construction surface to convey sound deadening or sound proofing to the construction surface.

13. The liquid or paste of claim 5, wherein the construction surface comprises wood surfaces, metal surfaces, concrete surfaces, surfaces of mechanical or plumbing fixtures or surfaces of insulation.

14. The liquid or paste of claim 4, wherein the fireproof adhesive is selected from a group consisting of one of cements, glues, mucilage, and pastes.

15. A fireproof construction panel or tile, comprising:
a) a gypsum powder at least in part derived from a gypsum component of drywall;
b) a fibre component at least partly from backing or facing papers of drywall;
c) one or more binding agents; and
d) one or more lightening materials
wherein the fibrous component provides the bulk density and structural integrity to the construction panel or tile.

16. The fireproof construction panel or tile of claim 15 further any one or more components selected from the group consisting of fireproofing agents, foaming agents, adhesives and sound deadening materials.

17. The fireproof panel or tile of claim 15 wherein the one or more lightening materials comprise mineral fibers, perlite, and fiberglass.

18. The fireproof panel or tile of claim 15, wherein the fireproof panel or tile is manufactured by pressing; pouring and setting; extruding and forming; foaming, extruding and forming; spraying and forming or laminating.

19. The fireproof panel or tile of claim 15, wherein said fireproof panel or tile is configured to be adhered, bonded, or mechanically affixed to surfaces including wood, steel, concrete, mechanical or plumbing fixtures or insulation surfaces, to provide fireproofing or sound deadening qualities thereto.
